(19) United States
(12) Patent Application Publication
(10) Pub. No.: US 2016/0343036 A1
(43) Pub. Date: Nov. 24, 2016

(54) METHOD AND SYSTEM FOR DYNAMIC ADVERTISING BASED ON USER ACTIONS

(71) Applicant: 140 Proof, Inc., San Francisco, CA (US)

(72) Inventors: Jon Elvekrog, San Francisco, CA (US); John Manoogian, III, San Francisco, CA (US); Erik Michaels-Ober, San Francisco, CA (US)

(21) Appl. No.: 15/184,485

(22) Filed: Jun. 16, 2016

Related U.S. Application Data
(63) Continuation of application No. 14/203,223, filed on Mar. 10, 2014.
Application No. 14/203,223 is a continuation of application No. 12/820,089, filed on Jun. 21, 2010, now abandoned.
(60) Provisional application No. 61/289,847, filed on Dec. 23, 2009.

(51) Int. Cl. G06Q 30/02; H04L 29/08

(52) U.S. Cl. CPC G06Q 30/0269; H04L 67/306; G06Q 50/01

(57) ABSTRACT

A method and system for dynamically responding to advertisement reactions of a user in social network that includes serving an initial advertisement to a user of a social network; gathering a response action of the user associated with the initial advertisement; categorizing a quality of the response action of the user; creating an advertiser response based on the quality of the response action; and sending the response to the user.

### CROSS-REFERENCE TO RELATED APPLICATIONS

This application is a continuation of U.S. patent application Ser. No. 14/203,223, filed Mar. 10, 2014, which is a continuation of U.S. patent application Ser. No. 12/820,089, filed Jun. 21, 2010, which claims the benefit of U.S. Provisional Application No. 61/289,847 filed Dec. 23, 2009, both of which are incorporated in their entirety by this reference.

### TECHNICAL FIELD

This invention relates generally to the advertising field, and more specifically to a new and useful method and system for dynamic advertising based on user actions in the advertising field.

### BACKGROUND

Traditional advertising is generally applied to a static audience based on demographics. There are few opportunities for advertising to be targeted specifically for individual users, and advertisement campaigns are instead designed for large groups. Online social networks and, in particular, content streams have seen a rapid increase in use in recent years. Such social networks contain individual user information that could potentially be used by advertisers to target particular users. There is a great desire to integrate advertising with the conversations and content of users in this new form of social media. However, such a combination is often viewed as intrusive, annoying, and possibly a violation of privacy by users. Advertisers have failed to find ways to meaningfully take advantage of the access to users made available through social networks. This invention provides a new and useful method and system for dynamic advertising based on user actions, which overcomes the problems and shortcomings of conventional techniques.

### BRIEF DESCRIPTION OF THE FIGURES

FIG. 1 is a schematic representation of a method of a first preferred embodiment of the invention;

FIG. 2 is a flowchart representation of a method of a preferred embodiment of the invention;

FIG. 3 is a schematic representation of a method of a second preferred embodiment of the invention; and

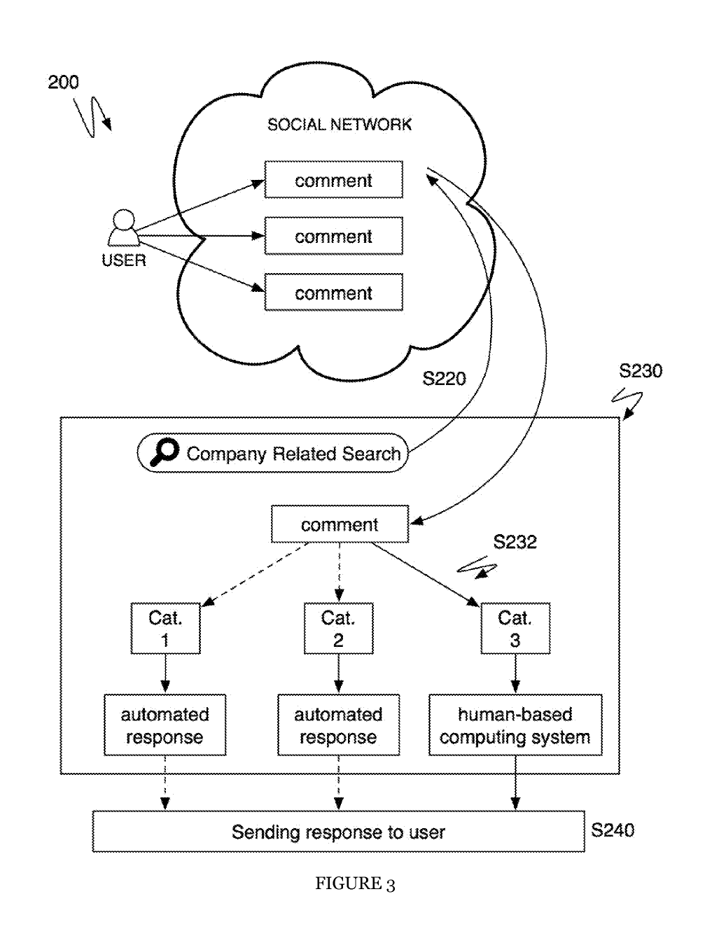

FIG. 4 is a schematic representation of a system of a preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

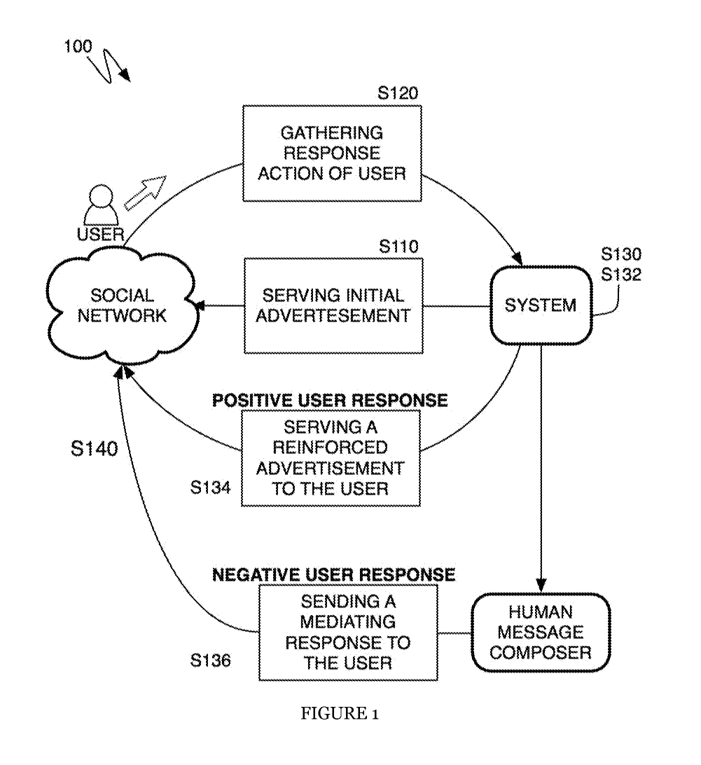

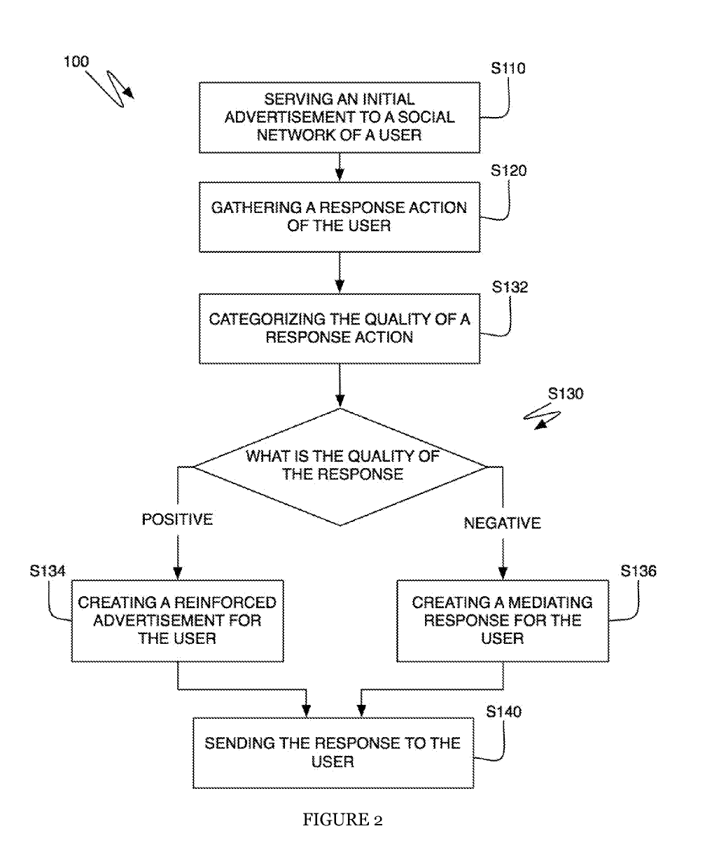

As shown in FIGS. 1 and 2, the method 100 for dynamic advertising based on user actions of the preferred embodiment includes serving an initial advertisement to a social network of a user S110, gathering a response action of the user S120, and creating an advertiser response to the response action S130, and sending the advertiser response to the user S140. The creation of an advertiser response preferably creates an appropriate response based on the individual actions of the user. For example, if the response action is determined to be positive, Step S130 preferably includes creating a reinforced advertisement for the user S134. If the response action is determined to be negative, Step S130 preferably includes creating a mediating response for the user S136. The method functions to create an advertisement campaign that is reactive to the dialogue and indirect actions of a user. The method functions to utilize the open conversation nature of social networks to detect comments and feelings of a user that typically are not accessible by interested parties. The method not only functions to react to indirect user behavior, but an entity can preferably form a more personal connection between the user and the entity by forming personalized responses. An indirect user behavior preferably describes a reference to an advertisement or company made through a social network. Direct responses may additionally or alternatively be a cause for a reaction by an advertiser. The advertisements produced by such a method are preferably more humanized and reverse or prevent negative opinions from being established by a user because the advertiser can respond manually or automatically to users' reactions to the advertisements. The method preferably enables personalized advertisements to be integrated with a user conversation, based—in part—because of the personalized dialogue carried out through the advertisements. The method is preferably used within a social network. A social network is preferably an internet based web platform with a plurality of user accounts that the user interacts with through a content stream of the user. The user preferably establishes social network connections with other users, and can preferably carry on conversations over the social network either through user referencing, conversation thread references, or any suitable mechanism. The method is more preferably used within a content stream on a social network (such as the Twitter micro-blogging platform), but may alternatively be used within any suitable user based website. A content stream of a user is preferably a compiled list of chronologically ordered text-based posts created by social network connections of the user, but may additionally or alternatively include any suitable media. The advertisements may alternatively be in the form of any suitable computer media such as text, pictures, video, audio, interactive media, or any suitable multimedia.

Step Silo, which includes serving an initial advertisement to a social network of a user, functions to distribute content to a user. The content is preferably an advertisement, and more preferably is an advertisement included within the social stream of a user. The advertisement may alternatively be displayed anywhere within the social network or in connection to the user of the social network. Given the disconnected nature of internet websites where content and advertisements may be assembled from several places, the advertisements may be served in one of multiple variations. In a first approach, the requesting client requests content from one API and advertising data from another API, and then merges them together. In another approach, the advertising service may accept a request from a client, fetch an external content feed via an API, insert an advertisement, and return the merged feed with the advertisement to the client. This latter approach requires fewer changes for an ad-serving client, but may introduce limitations in the form of the advertising service performing additional work. As an example, on a social network website like Twitter.com, the advertisement may include a positive description of the product being advertised, written by another user on that social networking site and including a visual image (“icon”) of that user as a “testimonial,” in the form of a “retweet” post. These retweet posts function as a way to demonstrate and encourage positive social reaction to the advertisement, fostering further distribution of the advertising message. As another example, the advertisement may include comments on a blogging thread of the particular user. The advertisement may alternatively have been served to any suitable website accessible by members of a social network. In this alternative, the user may discover the advertisement on a profile or social stream of a friend or possibly see the advertising content on a site with social network user integration (e.g., via a commenting or sharing system). The advertisement may have been selected based on demographic or profiling information about the user, but the content may alternatively be randomly selected. In one preferred variation, a user summary is preferably created for the user. The user summary preferably characterizes the characteristics of the user and is preferably formatted as keywords along various vectors such as location, interests, influence, following, etc. An advertisement summary is preferably additionally created for a plurality of advertisements, and the initial advertisement is preferably served based on the similarity of the user summary to an advertisement summary of the initial advertisement. The method 100 may be used in an iterative nature such that the initial advertisement is an advertisement created as a product of the method 100 (e.g., a reinforced advertisement or a mediating advertisement).

Step S120, which includes gathering a response action of the user, functions to collect and analyze the reaction of a user to the initial advertisement. When receiving an advertisement in a social stream, there are a multitude of actions a user may take. Actions made through a social network are preferably gathered and user opinions of the initial advertisement are interpreted through the actions. One response action may be a sharing action or a redistribution of all or part of the content of the initial advertisement. The redistribution of the advertisement by a user is generally taken as a positive sign that the advertisement effectively received the attention of the user. Another response action may be a referencing action where a user mentions or links to an entity associated with the advertisement. A reference is preferably identified within user created content on the social network. There are various methods and systems that social networks have in place for a user to either mention a user (such as through a tagging system like the use of the “@” symbol followed by a user name) or a concept (such as through a tagging system like the use of “#” hashtags followed by the concept). An entity associated with the advertisement may include the user that posted the advertisement, the user name of the advertising company, a tag referenced in the advertisement, or any way of linking the reference to the advertisement. The reference action may additionally be a direct reply to the advertisement. Other response actions may be advertisement interaction, which could vary depending on user interaction affordances in the content of the advertisement. A user may click a link, may play a video file, listen to a music file, view a slideshow, interact with interactive media (e.g., a game), install an application, or perform any suitable action made available by the advertisement. Such advertisement interactions are additionally gathered as response actions.

Step S130, which includes creating an advertiser response to the response action, functions to generate an appropriate message that more personally addresses the comments of the user. The advertiser response can preferably be adapted to reinforce a reaction such as if the comment indicated a positive experience with the advertisement, mediate a reaction such as if the comment indicated a negative reaction to the advertisement, the advertiser response may be adapted to solve a problem indicated by the comment, or make any suitable reply. Step S130 preferably additionally includes categorizing a quality of the response action of the user S132, which functions to detect how the response action should be interpreted. The response action is preferably analyzed to produce a positive/negative quality score, in which a positive score indicates that the user had a favorable experience because of the advertisement, and a negative score indicates that the user had an unfavorable experience because of the advertisement. The quality of the response action may alternatively be groups assigned to common types of reactions or advertiser response types. For example, the quality of a response action may be detected as “found advertisement funny or entertaining”, “found advertisement useful”, “complained of repeated advertisement”, “complained of irrelevant advertisement”, or any suitable category for a response to an advertisement. In creating response actions the user may additionally generate a message. For example, when performing a sharing action or reference action, the user can write their own message that accompanies the resulting content of those actions. User messages are preferably analyzed to determine the quality of the response action. The quality of the response action as indicated through the message is preferably analyzed using natural language processing or any suitable system. Alternatively or additionally to the use of natural language processing, human based computing techniques may be used for categorizing the negative or positive attitudes of users in their responses to advertisements. Human based computing, such as Amazon's crowd-sourcing service Mechanical Turk, uses people as a way of completing a task in line with a computer system. For this step, workers may be used to assign the quality to a response action. In one example, human-based computing techniques may be used when natural language processing is unable to determine the tone of the user. In another example, human-based computing techniques may be used after an initial automatic sorting (such as by using natural language processing).

Following the determination of the quality of a user action, an advertiser response is preferably created which preferably includes creating a reinforced advertisement for the user S134 or creating a mediating response for the user S136. Step S132 and S136 are preferably performed if the quality is detected to be positive or negative, respectively. The advertiser response may be automatically generated or may be wholly or partially tailored for the user by a human through a human based computing service. The response action of the user along with any suitable guidelines such as mediating template or a reinforced template, which may be used for crafting advertisement responses. Other advertiser responses may additionally be used for different detected qualities of response actions. If the user has a neutral response action to the initial advertisement either reinforced advertisements may be created or any suitable action may be performed, depending on several factors (including the direction of the advertiser). Other forms of advertiser responses may alternatively be created for any suitable detected quality in an advertisement. Advertiser responses are preferably messages such as private messages or a new advertisement, but the advertiser responses may be an action performed within the advertising system such as altering a user profile used for selecting advertisements. Additionally or alternatively, a user summary may be adjusted according to the quality of the response action. The user summary is preferably updated such that similar advertisements would less likely be served to the user. As an alternative, the advertisement and/or similar advertisements may be added to a blacklist of advertisements or content of the user summary that will not be served to the user.

Step S134, which includes creating a reinforced advertisement for the user if the response action is determined to be positive, functions to focus advertising to a user in an area where the user appears to be reacting favorably. The reinforced advertisement may be a new advertisement with a similar target demographic. For example if an initial advertisement was targeting 20 year old males and the user response action was positive then additional advertisements that target 20 year old males would be sent to the user. Alternatively, the reinforced advertisement may be an advertisement for similar subject matter. For example, if an initial advertisement for clothing received a positive response action then the reinforced advertisement would also be for clothing. The reinforce advertisement may alternatively or additionally be similar advertisement forms. Some initial advertisements may be conducive to particular types of response actions such as sharing, referencing, media interaction, or any suitable form of response action. In this way, reinforced advertisements that are sent to a user are tailored for the types of response actions commonly performed by that particular user. Additionally, when the method 100 is used with a user profiling system, the user summary may be updated accordingly to reflect the characteristics of advertisements that result in positive response actions by the user. The parameters that caused the initial advertisement to have been sent to the user (such as shared keywords between the user summary and the advertisement summary) may be weighted more strongly when comparing the user summary to subsequent advertisements.

Step S136, which includes creating a mediating response for the user if the response action is determined to be negative, which attempts to nullify or prevent negative opinions from being established by a potentially upset user. The mediating response is preferably more personalized in tone than the initial advertisement. The mediating response preferably functions to make the creator of the advertisement response and the initial advertisement appear to be more personable. In some situations, this can result in a user altering their opinion of the initial advertisement and performing a positive response action. However, the main objective of the mediating response is preferably to neutralize or at least lessen the negative feelings of the user towards the initial advertisement. Additionally, the mediating response may additionally be used to solve problems or issues. For example, the response action of the user may refer to a particular problem, which the mediating response may attempt to resolve. The mediating response may be automatically performed. The negative response action of the user may be categorized into a group which has a preassigned response that is sent to the user. The mediating response is preferably a message to the user, which may be a private message such as an email or social network message or a reply added to a content stream conversation. The mediating response may alternatively be partially automated through human-based computing. In this variation, a person preferably selects an appropriate response for a negative response action of a user and/or fills in a form with content customized for the user. As yet another alternative, the mediating response may be completely created by a human who personally responds to the negative response action of the user. Additionally the creation of the mediating response may be dynamic, with the number of human written responses being indirectly proportional to the number of users generating negative response actions. The dynamic nature of human and automated responses may alternatively be dependent on the degree of the negative quality of a response action. Additionally, when the method 100 is used with a user profiling system, the user profile may be updated according to reflect the advertisements that cause unfavorable reactions by a user. Particular advertisements, companies, or forms of advertisement may be blacklisted for a particular user once a negative response action has been determined.

Step S140, which includes sending the advertiser response to the user, functions to deliver the advertiser response to the user. The advertiser response is preferably sent to the user as a private message, but the advertiser response may alternatively be publicly directed to the user through the social network, such as posting a reply to the user on a content stream of the social network. The sent advertiser response may alternatively be sent to the user as a second advertisement (e.g., a reinforced advertisement). The response may alternatively be sent to the user in place of a subsequent advertisement. In this way a conversation may be able to played out through advertising space.

As a first exemplary application of the above method, a user may find an advertisement for a 10% off sale on a music album. The advertisement is displayed on a website that has enabled the functionality to share the advertisement through a social network. Users frequently share content that they find to be notable, whether positive or negative. By monitoring the ongoing content stream of the upstream social network, e.g. Twitter.com, the system can detect when advertisements are shared by users, can categorize the user's assumed reason for sharing as either positive, negative, or other, and can route the user's profile appropriately based on predetermined instructions. For example, the user may find the contents of the advertisement entertaining, useful, educational or any suitable positive description. Since users of social networks actively produce content, the user may share the contents of the advertisement with his own appended comment of “wow this is great! <advertisement content>”. Through the above method, the sharing action of the user is detected. A natural language processor detects the positive words of “wow” and “great” within the message of the user and assigns a positive quality to the response action of the user. The method then creates reinforced advertisements for the user by sending more music focused advertisements, notifying the user of advertisements with sales, and/or updating the user profile to indicate the user is more responsive to music and sales.

As a second exemplary application of the above method, an advertisement for a women's clothing store may be inserted into the content stream of a user. The user who happens to be male may find this advertisement odd and even a bit insulting. He may reply to the advertisement by saying “Why are you sending this to me?! I'm a guy! >:(” The natural language processing may detect elevated emotion from the punctuation and negative feelings from the emoticon of an angry face. A negative quality score is assigned to his response action or may be assigned to an “inappropriate advertising” quality category. The method then may send a customized message to the user apologizing for the inappropriate advertising. The method would select the template of: “<insert user name>, sorry for the mix-up. We won't send you anymore <insert type of advertisement>. <insert friendly comment>”. A worker (of a human-based subsystem) may be sent the message of the user and fill in the blank fields of the template to create the message: “@user, sorry for the mix-up. We won't send you anymore women's clothing information. Maybe think of us though when looking for something for your girlfriend next Valentine's day :)”. This message is then sent to the user as a private message on the social network. This preferably leaves the user with better feelings towards the advertising company.

As a third exemplary application of the above method, an advertisement may be inserted into the content stream of a user. If the user responds to that advertisement with user generated post on the content stream, that text can be analyzed to determine its most probable language (based on character frequency and semantic analysis). If the user's response is predicted to be in a different language than the initial advertisement, the advertiser can draw upon a previous list of pre-generated informational messages in different languages, use the language of the user's response to choose a message, and send that message to the user in the correct language so that the user can better understand the advertisement.

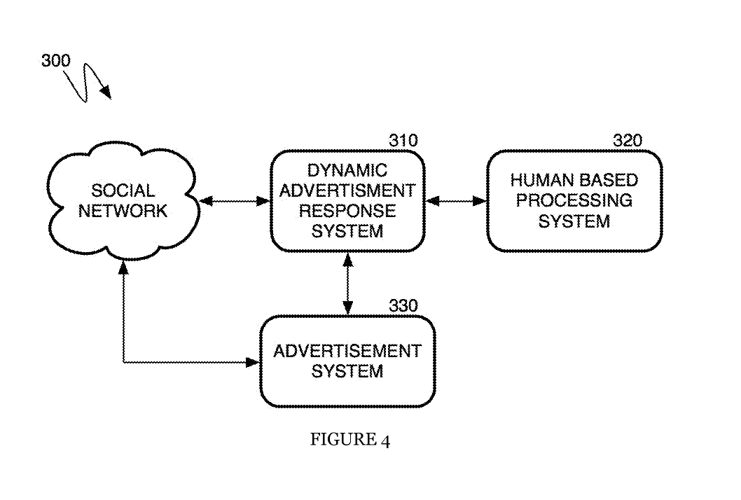

As shown in FIG. 4, a method 200 for dynamically interacting with users based on user actions of the preferred embodiment includes searching for indirect comments of a user directed at an interested entity S220, creating a response to the comments S230, and sending the response to the user S240. Method 200 functions to provide personalized feedback. Method 200 can be used in similar applications as method 100. Method 200 can preferably be used without an initial advertisement or content as a catalyst. One application of method 200 may be to provide customer support to users through a social network. Method 200 may alternatively be used as a public relations tool of an interested entity. Another application may be to engage users that respond to particular events, where the events may be in the social network or outside of the social network. Yet another application, may be used for assessing automatic content feeding through the social network such as promoted tweets, recommended social network connections, or advertisements. Method 200 uses the indirect actions of a user and the open conversation nature of the social network to identify suitable users and provide a relevant/personalized response. The method 200 is preferably used within a content stream on a social network (such as the Twitter micro-blogging platform), but may alternatively be used within any suitable user based website. Method 200 is preferably similar to method 100 and the methods can preferably share any suitable steps and variations.

Step S220, which includes searching for indirect response actions of a user directed at an interested entity, functions to discover social network actions by a user that relate to a particular entity. An interested entity may include an advertiser, a company, a celebrity or public figure, and/or any suitable party that might have a stake in the opinions and statements of public users. The search is preferably conducted by searching a social network for comments or conversations by users that include select phrases. The phrases may be keywords such as a name of a company, product, person, or any suitable object related to the interested entity. The select phrase may alternatively or additionally include user names of the social network such as a username of the interested entity. The select phrase may additionally or alternatively include tags or categorization keywords related to the interested party. The search may additionally or alternatively search for references to content related to the interested entity such as media or URI's linking to a website of the interested entity. A content stream of a social network is preferably searched but other areas of the social network such as profile pages, pages, fan sites, galleries or any suitable portion of a social network may be searched. Step S220 may additionally or alternatively include techniques described in Step S120. The search preferably returns content generated by a user such as a content stream post, a message, a reply or comment on a social network, or any suitable user generated content. The search may additionally be filtered so that only content that relates to a particular context is returned. The context preferably includes additional terms that a message must include. For example, a software company attempting to provide proactive customer service may have context terms for various issues with products of the company such as “error”, or “crashing”. The search may alternatively filter by the type of statement in the content such as identifying questions by punctuation or question words like “how”, “what”, “where”. A subset of users may alternatively be searched for indirect comments such as users that have received an initial advertisement.

Step S230, which includes creating a response to the comment, functions to proactively communicate to a passive comment of a user. Step S230 preferably includes categorizing the response action of the user S232, which functions to detect how the response action should be interpreted. Step S232 additionally functions to categorize the response action so that an appropriate reply may be created by the interested party. Step S230 is preferably substantially similar to Step S132 of Method 100. Method 200 may additionally include additional filtering and categorization of the content to group response actions by topic. The quality of the response action may be determined after the content has been filtered into related groups. For example, the results of the search may have content relating to general comments about a company and also content relating to a common problem with a product. As these two categories of content preferably would receive different mediating responses, the content is filtered into two appropriate categories before analyzing the quality Additionally, content that does not fit a particular category may be collected. This may be used as a flag for interested entities on how wide spread a particular concept is within a social network. Such uncategorized content may not have a response template ready for use. Once an uncategorized type of content has passed a threshold a response template may be requested from the interested party.

Step S230 preferably additionally includes creating a reinforced response for a comment with a positive quality and a mediating response for a comment with a negative quality which are preferably substantially similar to steps S134 and S136. As with Step S132, if the quality of the response is positive then a reinforced response is preferably generated. A reinforced response may be a message directed at the user thanking them, suggesting similar, offering promotional options. The reinforced response may alternatively include requesting to follow the user, redistributing (e.g., forwarding) the content of the user, or any suitable response. As with Step S136, if the quality of the response is negative then a mediating response is preferably generated. The mediating response may attempt to offer suggestions to the user if the user comment relates to a particular issue. Additionally or alternatively, the response may be other suitable deliverables within the social network such as media, social network connection suggestions, featured content, or any suitable content that may be actively provided to the user.

Step S240, which includes sending the response to the user, functions to send the message to the user. Step S240 is preferably substantially similar to Step S140. In some variations Step S240 may additionally include sending a social network connection (i.e., an entity to follow), content to try, or any suitable promotion of content.

As an exemplary application of the above method, a company may provide customer support to users through a social network. Problems that users encounter can preferably automatically identified, and response templates are preferably created automatically or through the use of a human-computing service. Common questions are preferably answered without the user actively searching for the answer.

As shown in FIG. 4, a system 300 for dynamic advertising based on user actions of the preferred embodiment preferably implements the above methods through a dynamic advertisement response system 310, and may additionally include an advertisement system 320 and a human-based computing sub-system 330. The system 300 is preferably in communication with or integrated within a social network and more preferably with a content stream of a social network. The dynamic advertisement response system is preferably in a computer-readable medium storing computer-readable instructions. The instructions are preferably executed by computer-executable components for capturing and analyzing the response action of a user and determining the advertisement response based on the user reactions. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device. The computer-readable medium 310 is preferably in network communication with the social network or alternatively a tool interfacing with the social network. The advertisement system 320 preferably includes advertisements or any suitable content and manages the serving of advertisements or content to social networks and other websites. The advertisement system 320 may additionally manage a plurality of user profiles defining the demographics and advertisement preferences of users. The advertisement system 320 preferably stores preferences of a user in a user summary. The human-based computing sub-system 330 preferably allows for human action events required for implementing the above system. The human-based computing sub-system 330 may be used for interpreting quality of message messages (e.g., positive or negative) and/or creating advertisement responses for a user (e.g., a reinforced advertisement or a mediating response). The human-based computing sub-system preferably 330 receives content, quality of the content and a response template from the dynamic advertisement response system 310, that is used to generate an appropriate response. In one variation, the human-based computing sub-system may be a crowd sourcing system.

As a person skilled in the art will recognize from the previous detailed description and from the figures and claims, modifications and changes can be made to the preferred embodiments of the invention without departing from the scope of this invention defined in the following claims.

We claim:

1. A method for dynamically responding to advertisement reactions of a user in a social network, the social network being an internet based web platform with a plurality of user accounts, comprising:
serving an initial advertisement to a user of a social network;
gathering a response action of the user on the social network associated with the initial advertisement;
categorizing a quality of the response action of the user;
creating an advertiser response based on the quality of the response action; and
sending the response to the user.
